(19) United States
(12) Patent Application Publication
(10) Pub. No.: US 2007/0201040 A1
(43) Pub. Date: Aug. 30, 2007

(54) LASER-BASED POSITION MEASURING DEVICE

(75) Inventors: Volker KONETSCHNY, Muenchen (DE); Klaus STROEL, Muenchen (DE)

Correspondence Address: ROBERTS, MLOTKOWSKI & HOBBES, P. O. BOX 10064, MCLEAN, VA, 22102-8064, US

(73) Assignee: PRUEFTECHNIK DIETER BUSCH AG, Ismaning (DE)

(21) Appl. No.: 11/680,940

(22) Filed: Mar. 1, 2007

Related U.S. Application Data
(63) Continuation-in-part of application No. 11/210,102, filed on Aug. 24, 2005.

(30) Foreign Application Priority Data
Aug. 25, 2004 (DE) 10 2004 041 278.2

(51) Int. Cl. G01B 11/24; G01B 11/14

(52) U.S. Cl. 356/601; 356/614

(57) ABSTRACT

A position measuring device with a rotating laser beam includes a laser transmitter that is positioned in a polar coordinate system and emits at least one rotary laser beam in an essentially horizontally lying plane. A photosensitive position sensor delivers an electrical pulse, which is identified by length in time and phase angle, during illumination by the rotating laser beam. The phase angle and length in time of these pulses constitute a measure of the angular position and the radial distance of the sensor in the indicated polar coordinate system. Measurements are taken with the sensor generally positioned at predefined locations. The device determines the difference between the actual measurement point and the predefined target measurement point and adjusts the measurement data accordingly. The adjusted data is used to determine the flatness of a surface.

### CROSS-REFERENCE TO RELATED APPLICATIONS

This application is a Continuation-in-Part of co-pending application Ser. No. 11/210,102, the entirety of which is incorporated herein by reference.

### BACKGROUND OF THE INVENTION

1. Field of the Invention

The invention relates to a laser-based position measuring device.

2. Description of Related Art

Position measuring devices are available in many types. One well-known type is known under the generic term “total station.” A total station is combination of an electronic theodolite or transit and an electronic distance measuring (EDM) device with associated computer based software. Angles and distances from the instrument to points to be surveyed are measured, and the coordinates of the actual positions of the points are calculated.

Most total station instruments measure angles by electro-optical scanning of extremely precise digital bar-codes etched on rotating glass cylinders or discs within the instrument. Distance measurement is often accomplished with a modulated microwave or infrared carrier signal that is generated by a small solid-state emitter within the instrument's optical path and reflected from the object to be measured. The modulation pattern in the returning signal is read and interpreted by a computer associated with the total station. The speed-of-light lag between the outbound and return signal is translated into distance. Most total stations use a purpose-built glass prism as the reflector for the EDM signal and can measure distances out to a few kilometers. The reflector is typically held by a person at various positions in the survey while an operator operates the device. However, it is also possible to have robotically operated devices in which the operator can remotely control the machine, while holding the reflector. These devices are quite complex and are very expensive.

There is a need for a simpler, and thus less expensive, device for use when less detailed measurements are desired to be taken. For example, when determining the relative geometry of an object, a full survey with precise distance measurements may not be necessary. A less complex system would be useful in these situations.

### SUMMARY OF THE INVENTION

An aspect of the invention is to provide a device that is more economical than the known devices and can be used for less stringent 2- or 3-dimensional measurement tasks.

Measurement tasks can be performed by this invention in diverse industries, such as measurements of flatness in machine tool construction. It is also possible to use it to determine flatness of machine foundations, to measure bed plates and tables, to precisely measure circular and rectangular flanges, to accurately measure machine half castings, and to precisely measure crane slew rings, for example.

These and other aspects of the invention will become apparent in view of the description and drawings below.

### BRIEF DESCRIPTION OF THE DRAWINGS

FIG. 1 is a schematic representation of a laser beam rotating in a horizontal plane generated from a device in accordance with the invention;

FIG. 2 is a plot of the laser pulses generated by a device in accordance with the invention;

FIG. 3 is an idealized laser pulse diagram;

FIG. 4 depicts the image of pulsed laser light points on a sensor; and

FIG. 5 is schematic diagram of a predefined coordinate grid showing an actual measurement point compared to a predefined target measurement point.

### DETAILED DESCRIPTION OF THE INVENTION

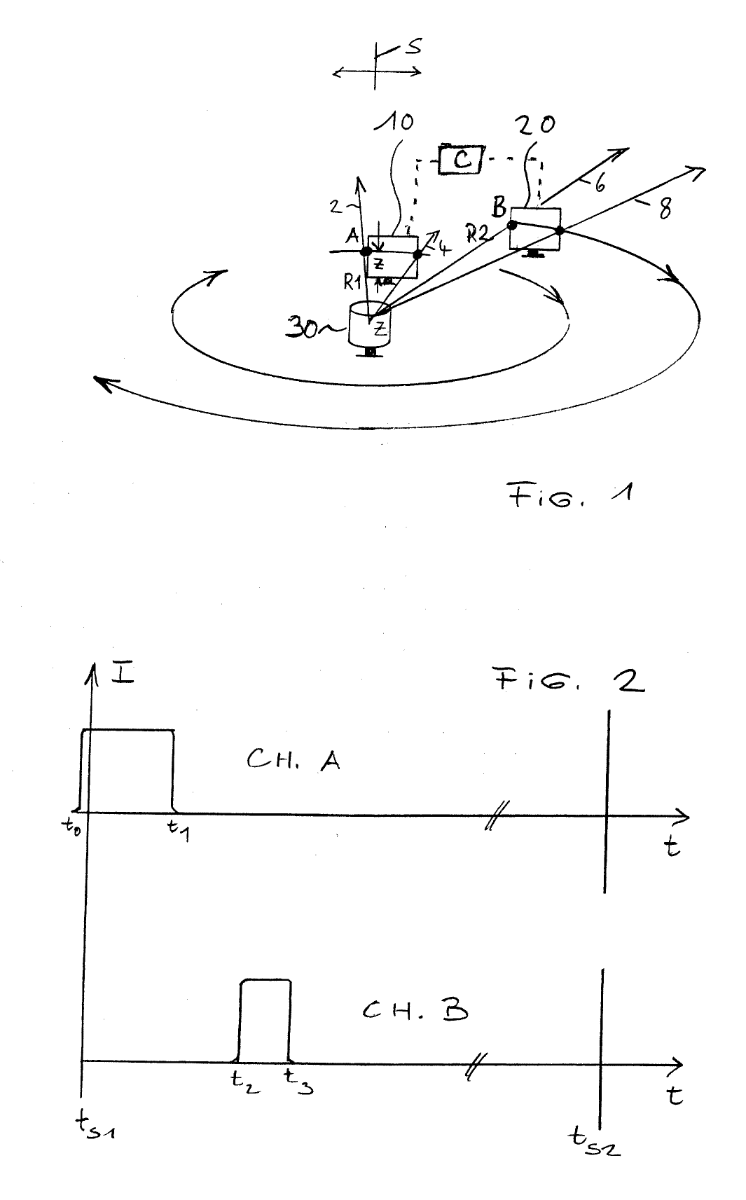

FIG. 1 schematically shows a laser beam that rotates in the horizontal plane AZB. To do this, a laser beam generator 30 is used that has a motorized means (not shown) with which a laser beam can be set into rotary motion around a central axis Z. In this case, the laser beam moves successively into positions 2, 4, 6, and 8 in the pertinent, essentially horizontally lying plane, which is very flat. The motorized means is made such that a very constant angular velocity of the laser can be maintained so that, for example, the deviation of the laser beam from the actual angular position relative to the theoretical angular position at any given instant is simply, for example, 10 E⁻⁴ rad (100 microrad). The components of such a motorized means are known. In times that periodically recur in an exact manner, the laser beam can therefore scan a reference mark S.

To determine the x- and y-position of, for example, a graduated ruler, at a certain position, a measurement sensor is positioned in a measurement plane that is to be checked in accordance with the invention. The measurement sensor can be an optoelectric detector for example, such as a semiconductor position detector. The sensor is able to generate a signal based on the site on the sensor at which a light beam impinges. A suitable signal is an electrical pulse identified by length of time and phase angle of the illumination by the laser beam. The signal can represent one-dimension, and preferably two-dimensions. In particular, the optoelectronic detector is relatively fast and within an extremely short time produces an output signal or an altered output signal as soon as light or additional light is incident on it.

According to the invention, the determination of the aforementioned x- and y-position is accomplished as follows. First, a radius angle determination is carried out in polar coordinates (rho, phi). The determined polar coordinates are then converted by electronics or a computer into an x- and y-position determination. The optoelectronic sensor of the invention therefore delivers signals which, depending on its position, have a different, but exactly definable phase angle that is determined, for example, by the rising edge of the measured pulse relative to cyclically repeated time zero points tₛ₁ and tₛ₂ which are stipulated on the laser beam generator (compare FIG. 2). Furthermore, according to the invention, the length in time of the signals delivered by the optoelectronic sensor is variable and depends essentially on the radial distance of the sensor from the center Z. If provisions are made for the receiving surface of the sensor to be oriented perpendicular to the incident laser beam, therefore based on the length of a pulse in time and its phase angle, the coordination of the measurement point by radius and relative angle with respect to a starting angle can be undertaken.

For example, FIG. 1 shows a sensor 10 that is positioned at a radial distance R1 at position A, over which a laser beam generated by laser beam generator 30 is swung from the initial position 2 to the end position 4, at a height “z”. As long as the sensor 10 is illuminated by the laser beam, at least one signal is delivered. However, the sensor 10 is devised such that, preferably, two signals can be delivered that contain information about the impact point of the laser beam according to two coordinates at positions 2 and 4. The time signal, which is present during illumination of the sensor 10 by the laser beam, is shown in FIG. 2 over the time between the instants t₀ and t₁ as a channel A (“CH.A”). A data processor, such as a computer C shown schematically in FIG. 1, with programmable circuitry or software based control system is in communication with the sensor 10 and, if desired, the generator 30 to receive and interpret the signals generated from the sensor 10 and, if desired, to control operation of the generator 30. The computer C can be coupled the sensor 10 and generator 30 in any known manner, especially in a wireless manner to facilitate an efficient measurement procedure.

If the same or a second sensor 20 is positioned at position B with a radial distance R2, the laser beam can illuminate it between the angular positions 6 and 8, beginning from position B, which can have a ordinate value different than that in position A. The respective delivered electrical pulse is shown in FIG. 2 in the lower part as a channel B signal (“CH.B”) between the instants t₂ and t₃. The instants t₂ and t₃, therefore, in this example, are later than t₀ and t₁. The corresponding time difference of the pulse centers is therefore a measure of the angle AZB. Furthermore, the pulse widths (t₀-t₁) and (t₂-t₃) are different, due to the respectively identical measurement surface of the sensor 20 and the different radial distances in the different measurement positions. For a fixed sensor that remains in one position, comparable pulses arise with each beam passage so that data from several pulses, for example, 5 to 70 pulses, can be combined into a mean value. Such a mean value then has higher precision than only a single measurement value.

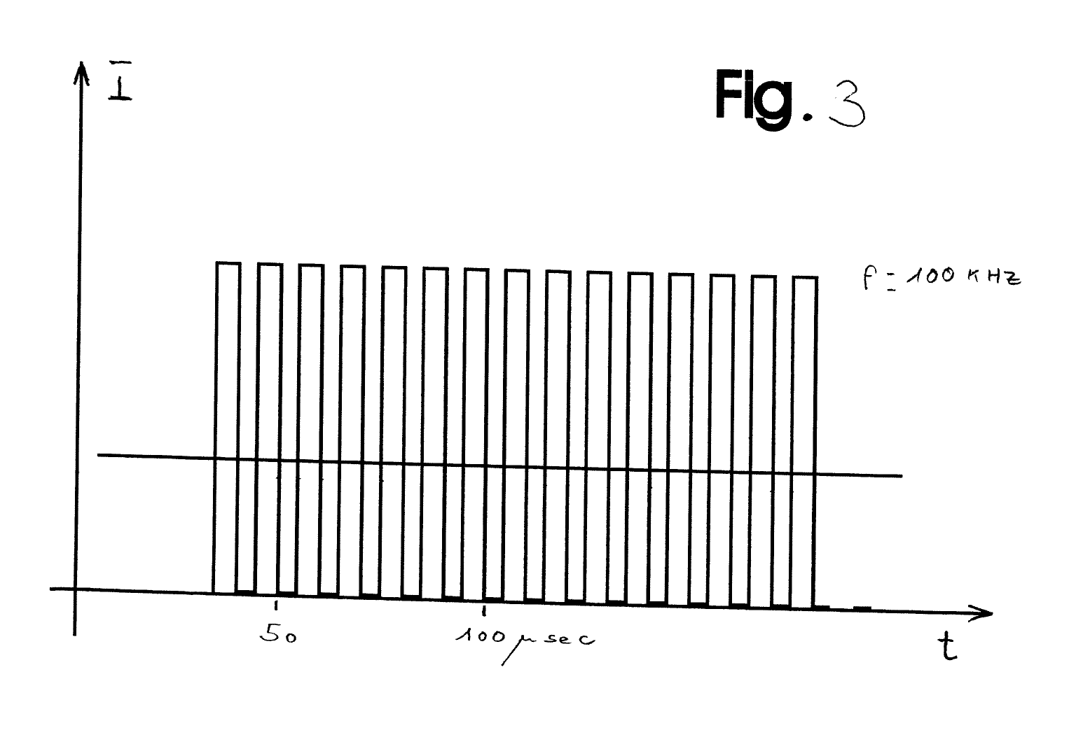

In one modified embodiment of the invention, a laser beam is used which likewise rotates uniformly, but pulsates, so that during its rotation with a frequency of, for example, 100 kHz, it is continuously turned on and off. The frequency can also be altered, for example, with one revolution of the laser taking place in continuous wave operation, followed by one revolution with 100 kHz pulse frequency, then a revolution with 30 kHz, then one revolution with 10 kHz or the like, without the rotary motion being modified in any way. In this case, the sensor 10, for example, can therefore both detect pulse times and also can have the number of individual pulses counted by a downstream counter or computer C. In this way, a measure of the time that the laser beam had required to scan the sensor from one edge to another is made available. A corresponding idealized pulse diagram is shown in FIG. 3.

With a laser pulse that has been modulated in this way, i.e., a pulsating laser pulse, it is likewise possible to use a surface with individual pixels, instead of detectors or sensors, which act over an entire surface (so-called position sensing diodes). A surface with many individual pixels works well if their sensing surface is dimensioned to be large enough. The pulsating laser beam then generates a string-of-pearls type pattern or strip-like pattern on the sensor that can be read out and evaluated until the next revolution. It is likewise possible to use pixel-oriented detectors of smaller dimensions if there are reducing imaging optics. In this case, it is feasible to allow the laser beam to pass over a diffusing screen of defined size, for example, 50 mm width, and to image the picture of the diffusing screen together with the laser light incident there by means of a lens of roughly 10 mm focal length onto a pixel-oriented detector.

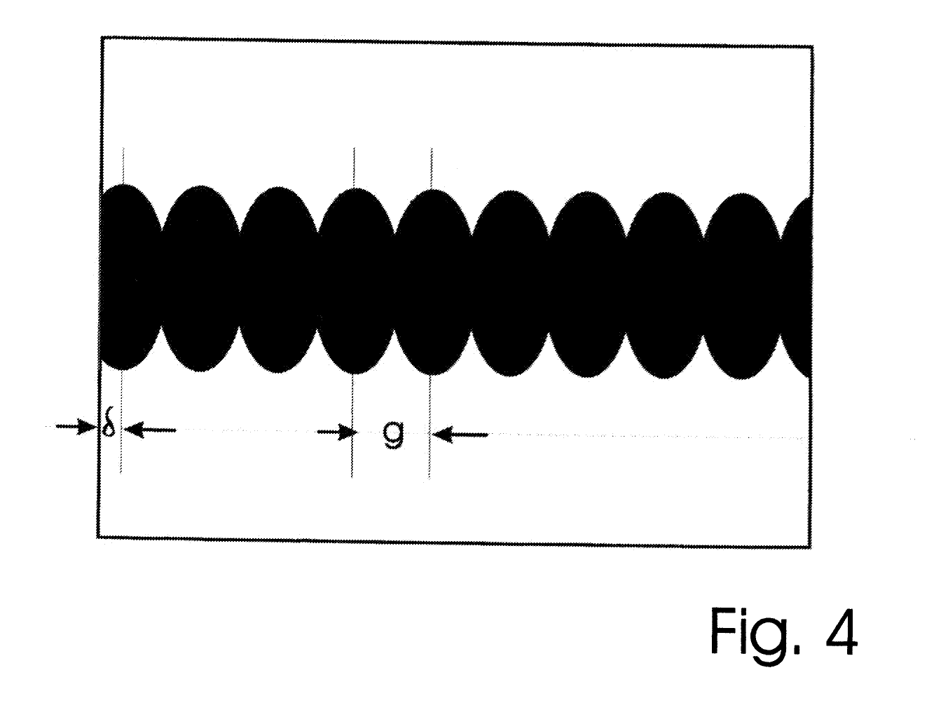

It is apparent that the number of individual laser light pulses registered by the sensor is a measure of the time that the laser required to scan the diffusing screen. An image of the pulsed laser light points on the sensor is shown in FIG. 4. As is recognized, the lattice constant (reference letter “g” in FIG. 4) relative to the dimensions of the sensor is a measure of the radial distance of the sensor from the center Z. With this information, the precision of the measurement can be further improved. Likewise, based on the periodicity of the registered point sequence, the phase angle “delta” can be determined with relative accuracy. With this phase information, it is therefore possible to more accurately determine the edge position of the pulses, as shown, for example, in FIG. 2, and thus, the desired azimuth value of the position which is to be measured. To determine the quantities “g” and “delta” different mathematical methods can be used, for example, those of a Fourier transform, especially one which is applied to all detected pixels.

In addition to the data for its coordinates (by radius and azimuth angle), the sensor 10 can thus simultaneously deliver a leveling value (height value or z-component) to the controller C from the respective measurement position so that, with a small number of system components, an especially economical measuring device that measures in three dimensions is provided.

In this case, the relative flatness of a surface can be determined by using the position identified on the sensor 10 of the rotating horizontal laser beam to generate data relating to the relative height of the sensor. By positioning the sensor 10 at different points of the surface and taking measurements at these points, the laser beam will change its position on the sensor according to the deviation in relative height. The deviation at each measurement position thus provides data as to the relative flatness of a surface without the need to take extensive detailed measurements of angular displacement of beam with respect to the measurement device, as is required in the more complex prior art devices.

In operation, a grid of measurement points is defined across a coordinate system on the surface to the measured. The measurement points are established at predefined locations in an evenly spaced pattern. Each predefined location represents a point at which measurement will occur, i.e. where the sensor will be positioned. Then, the measurement process explained above is executed to determine the deviation and thus the relative flatness. One inherent inaccuracy that can occur with this method is imprecisely positioning the sensor with respect to the predefined target measurement point. To overcome this inherent issue, in accordance with this invention, the process includes an automatic self correcting function.

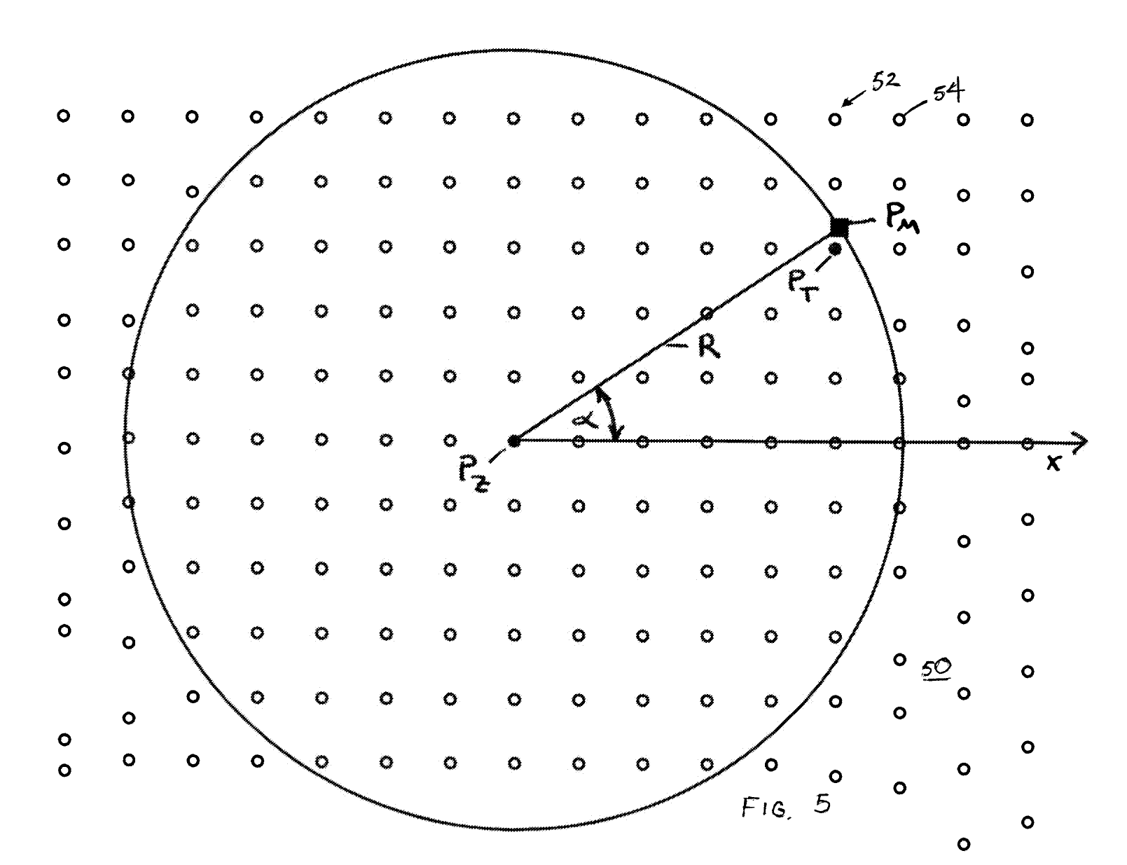

Referring to FIG. 5, a surface 50 to be measured for flatness is shown. A grid 52 of measurement coordinates 54 is defined on the surface 50. The coordinates of each point 54 of the grid 52 are stored in a data base accessible to the computer C, as seen in FIG. 1. The measurement device or laser beam generator 30 is positioned at a generally central point P_{Z} and a measurement for the coordinate P_{M} is taken by passing the laser beam over a sensor 10 at P_{M}, which generates a signal that corresponds to the absolute radial (R) value and the angular (α) value with respect to the x-axis or plane.

The signal is provided to the computer C, which uses the measured values at point P_{M} to determine the coordinates of the point P_{M}. The computer C recognizes that the coordinates of P_{M} do not match the coordinates of the target measurement point P_{T}, by comparing the stored coordinates to the determined coordinates. The differences between the measured coordinates of point P_{M} and the target coordinates of point P_{T} are determined. The measured values are then adjusted using the determined differences so that the coordinates of P_{M} correspond to the predefined target coordinates of P_{T} from the grid 52. Thus, if the sensor 10 is not precisely positioned at the target measurement point, the system can accommodate the variance and correct the measured values.

Then to determine the relative flatness of the surface 50, the sensor 10 or another sensor 20 is positioned for the next measurement and the process is repeated, with the computer C making an adjustment for the predefined target measurement point and the actual measurement point. By this, any inaccuracies from positioning the sensor at a point other than on a point 54 on the predefined grid 52 can be automatically corrected. Thus, mispositioning the sensor can be accommodated to result in an assisted absolute measurement value.

Various modifications and changes may be made to the invention as set forth in the appended claims, including adding certain measuring and determination functions depending on the particular intended use. Also, different types of generators, sensors, and processors may be used.

What is claimed is:

1. A measuring device for measuring flatness of a surface, comprising:
a rotary laser beam transmitter located in a polar coordinate system defined on the surface to be measured, wherein the polar coordinate system includes a grid of defined measurement points, the rotary laser beam transmitter being rotatable about an axis at a constant rotary speed and adapted to emit at least one rotary laser beam in a fixed horizontal plane;
at least one photosensitive position sensor selectively positionable at a plurality of actual measurement points on the grid of defined measurement points in the plane of the at least one rotary laser beam, wherein the sensor delivers an electrical pulse in response to illumination by the laser beam that is representative of the position of the sensor at each actual measurement point in the polar coordinate system; and
a processor that receives the electrical pulses and determines data representative of the plurality of positions of the sensor at the actual measurement points, wherein the processor determines a difference between each position of an actual measurement point and the position of a target defined measurement point in the polar coordinate system and adjusts the determined data based on the differences between the actual measurement points and the defined measurement points to calculate relative height deviations of the sensor to determine the flatness of the surface.

2. The measuring device as claimed in claim 1, wherein the electrical pulse is representative of a length in time and a phase angle of the laser beam.

3. The measuring device as claimed in claim 2, wherein the electrical pulse is also representative of a location of impingement on the sensor of the laser beam.

4. The measuring device as claimed in claim 1, wherein the laser transmitter delivers a pulsed laser beam for producing a pulse train comprised of a plurality of individual pulses on the at least one photosensitive position sensor.

5. The measuring device as claimed in claim 4, wherein the photosensitive position sensor is one of a position sensing diode (PSD) and a pixel-oriented sensor of one of a CMOS and CCD construction.

6. The measuring device as claimed in claim 1, wherein the photosensitive position sensor is one of a position sensing diode (PSD) and a pixel-oriented sensor of one of a CMOS and CCD construction.

7. The measuring device as claimed in claim 1, wherein the grid is defined by a pattern of evenly spaced points.

8. The measuring device as claimed in claim 1, wherein the photosensitive position sensor is a semiconductor sensor.

9. The measuring device as claimed in claim 1, wherein the processor generates a flatness diagram showing deviation at each measurement point.

10. The measuring device as claimed in claim 9, wherein the processor includes a display that displays the flatness diagram.

11. The measuring device as claimed in claim 1, wherein the processor includes a memory that stores determined data for each measured surface.

12. The measurement device as claimed in claim 11, wherein the processor compares measured data to stored determined data and calculates deviations in the data.

13. A method of measuring flatness of a surface, comprising the steps of:
defining a coordinate system and storing coordinates representative of a grid of defined measurement points on the surface within the coordinate system;
generating a laser beam in a horizontal plane;
positioning a sensor within the coordinate system at a plurality of actual measurement points in the grid;
generating signals from the sensor at each actual measurement point based on illumination of the sensor by the laser beam;
determining coordinates of each of the actual measurement points and comparing the determined coordinates to the stored coordinates of the grid of defined measurement points to determine differences between the actual measurement points and the defined measurement points;
adjusting data based on the signals from the sensor for each actual measurement point to correspond to the defined measurement points; and,
determining relative flatness of the surface using the adjusted data.

14. The method as claimed in claim 13, wherein the step of generating the laser beam includes rotating the laser beam at a constant velocity.

15. The method as claimed in claim 13, wherein the step of generating the laser beam includes delivering a pulsed laser beam.

16. The method as claimed in claim 13, wherein the step of generating signals includes generating electric pulses representative of a length in time and a phase angle of the laser beam.

17. The method as claimed in claim 16, wherein the electrical pulse is also representative of a location of impingement on the sensor of the laser beam.

18. A process for determining flatness of a surface, comprising the steps of:
defining a coordinate system and storing coordinates representative of a grid of defined measurement points on the surface within the coordinate system;
receiving signals from a sensor positioned at actual measurement points in the grid based on illumination of the sensor by a rotating horizontal laser beam;
determining coordinates of each of the actual measurement points and comparing the determined coordinates to the stored coordinates of the grid of defined measurement points to determine differences between the actual measurement points and the defined measurement points;
adjusting data based on the received signals from the sensor for each actual measurement point to correspond to the defined measurement points; and,
determining relative flatness of the surface using the adjusted data.

19. The process as claimed in claim 18, wherein the process is performed by instructions stored on computer readable medium.
